(19) United States
(12) Patent Application Publication
(10) Pub. No.: US 2009/0212684 A1
(43) Pub. Date: Aug. 27, 2009

(54) REFLECTION PLATE AND LIGHT EMITTING DEVICE

(75) Inventors: Shintaro SAITO, Tsukuba-shi (JP); Sadanobu IWASE, Tsuchiura-shi (JP); Hiroshi HARADA, Tsukuba-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/388,821

(22) Filed: Feb. 19, 2009

(30) Foreign Application Priority Data
Feb. 25, 2008 (JP) 2008-042586

(51) Int. Cl. H01J 1/62; B32B 27/36; B29C 45/00; B29B 7/90; C09K 19/52

(52) U.S. Cl. 313/498; 428/220; 264/328.18; 252/299.01

(57) ABSTRACT

The present invention provides a reflection plate made of a resin composition comprising a liquid crystalline polyester, a titanium oxide filler and a silica-based filler containing 85% by weight or more of silicon oxide, wherein the resin composition contains the titanium oxide filler in the amount of from 5 to 80 parts by weight and the silica-based filler in the amount of from 0.01 to 20 parts by weight on the basis of 100 parts by weight of the liquid crystalline polyester. The reflection plate has an excellent reflectance, especially to light in a visible range, while maintaining excellent heat resistance of the liquid crystalline polyester.

### BACKGROUND OF THE INVENTION

1. Field of the Invention

The present invention relates to a reflection plate which is excellent in reflectance and heat resistance, and a light emitting device using the reflection plate.

2. Description of the Related Art

Liquid crystalline polyester has been utilized with titanium oxide as a filler because of its high moldability and high heat resistance, to provide a resin composition for producing a reflection plate for a LED (light emitting diode) light emitting device.

For example, Japanese Unexamined Patent Publication No. (JP-A-) 2007-320996 discloses that a resin composition containing a liquid crystalline, a titanium oxide and a blue coloring matter is useful for producing a reflection plate in the vicinity of a light source. Also, JP-A-2004-256673 discloses a reflection plate obtainable from a resin composition comprising a liquid crystalline polyester having a YI value of 32 or less and a titanium oxide.

It appears that the reflection plate obtained from the resin composition in JP-A-2007-320996 has a high reflectance only when a large amount of titanium oxide per a liquid crystalline polyester is used (for example, 100 parts by weight or more of the titanium oxide is added to 100 parts by weight of the liquid crystalline polyester for producing a molded article having a 85% or more of reflectance to light having a wavelength of 500 nm. The inventers of the present invention has realized that a larger amount of titanium oxide tends to deteriorate the liquid crystalline polyester. On the other hand, while the reflection plate in JP-A-2004-256673 has a satisfactory reflectance with a smaller amount of titanium oxide added, it may leave some room for improvement in the reflectance.

### SUMMARY OF THE INVENTION

One of objects of the present invention is to provide a reflection plate which possesses a high reflectance even when a titanium oxide is used in such an amount that it does not have adverse effects on the liquid crystalline polyester. Another one of objects of the present invention is to provide a reflection plate which has a high reflectance in a visible range while maintaining high heat resistance of liquid crystalline polyester and which can endure a high-temperature environment when mounted into a LED element.

The inventors of the present invention have intensively studied so as to achieve the objects described above, and thus the present invention has been completed.

Thus, the present invention provides a reflection plate made of a resin composition comprising:

(A) a liquid crystalline polyester,

(B) a titanium oxide filler, and

(C) a silica-based filler containing 85% by weight or more of silicon oxide,

wherein the resin composition contains the titanium oxide filler in the amount of from 5 to 80 parts by weight and the silica-based filler in the amount of from 0.01 to 20 parts by weight on the basis of 100 parts by weight of the liquid crystalline polyester.

Also, the present invention provides a method of producing a reflection plate, the method comprising the steps of preparing the above-described resin composition and then injection-molding the composition.

Further, the present invention provides a light emitting device having the above-obtained reflection plate and a light emitting element.

According to the present invention, a reflection plate with an excellent reflectance, especially to light in a visible range, can be obtained while maintaining excellent heat resistance of a liquid crystalline polyester. In the present invention, a reflection plate with a thin portion (for example, thin wall section) can be also obtained. A light emitting device having excellent characteristics such as luminance can be obtained by using the reflection plate, and thus the reflection plate is industrially extremely useful.

### DETAILED DESCRIPTION OF THE PREFERRED EMBODIMENTS

A reflection plate of the present invention is formed from a resin composition comprising:

(A) a liquid crystalline polyester,

(B) a titanium oxide filler, and

(C) a silica-based filler containing 85% by weight or more of silicon oxide, and the resin composition contains the titanium oxide filler (component (B)) in the amount of from 5 to 80 parts by weight and the silica-based filler (component (C)) in the amount of from 0.01 to 20 parts by weight on the basis of 100 parts by weight of the liquid crystalline polyester (component (A)).

Preferred embodiments with respect to these components (A), (B) and (C), a resin composition containing these components, a reflection plate using the resin composition, and a light emitting device will be described in the following.

### <Component (A)>

The liquid crystalline polyester used as the component (A) may be a polyester called a thermotropic liquid crystalline polymer, and can form a melt which exhibits optical anisotropy at a temperature of 450° C. or lower. Specific examples of the liquid crystalline polyester include:

(1) those obtained by polymerizing a combination of an aromatic hydroxycarboxylic acid, an aromatic dicarboxylic acid and an aromatic diol,

(2) those obtained by polymerizing different kinds of aromatic hydroxycarboxylic acids,

(3) those obtained by polymerizing a combination of an aromatic dicarboxylic acid and an aromatic diol, and

(4) those obtained by reacting a crystalline polyester such as polyethylene terephthalate with an aromatic hydroxycarboxylic acid.

In stead of using the aromatic hydroxycarboxylic acid, the aromatic dicarboxylic acid and/or the aromatic diol, it is also possible to obtain the liquid crystalline polyester using the ester forming derivative(s) thereof. There is an advantage that it becomes easy to produce a liquid crystalline polyester when using the ester forming derivative(s).

In the case of an aromatic hydroxycarboxylic acid or an aromatic dicarboxylic acid which has a carboxyl group in the molecule, the ester forming derivative includes those in which the carboxyl group in the acid compound has been converted into a highly reactive acid halogen group or acid anhydride group, and those in which the carboxyl group in the acid compound has been subjected to transesterification with alcohols or ethylene glycol to provide an ester (i.e., a polyester). In the case of an aromatic hydroxycarboxylic acid or an aromatic diol which has a phenolic hydroxyl group in the molecule, the ester forming derivative includes those in which a phenolic hydroxyl group and lower carboxylic acids form an acylated compound like formation of a polyester by transesterification of the phenolic hydroxyl group.

Furthermore, the aromatic hydroxycarboxylic acid, aromatic dicarboxylic acid or aromatic diol may have a halogen atom such as a chlorine atom or a fluorine atom, an alkyl group such as a methyl group or an ethyl group, or an aryl group such as a phenyl group as a substituent as long as ester forming properties are not inhibited.

Examples of a structural unit constituting the liquid crystalline polyester include the followings:

<Structural Units Derived from an Aromatic Hydroxycarboxylic Acid>

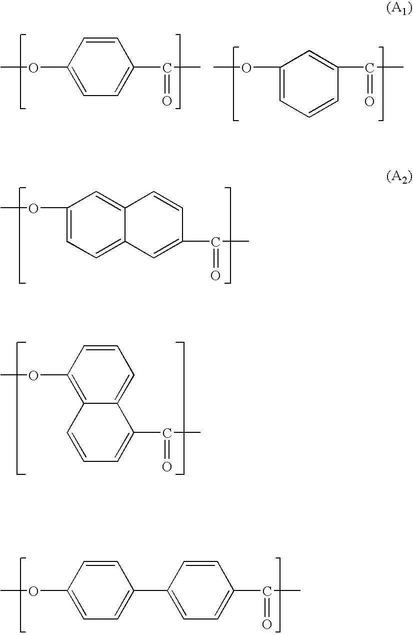

The above structural units may have a halogen atom, an alkyl group or an aryl group as a substituent.

<Structural Units Derived from an Aromatic Dicarboxylic Acid>

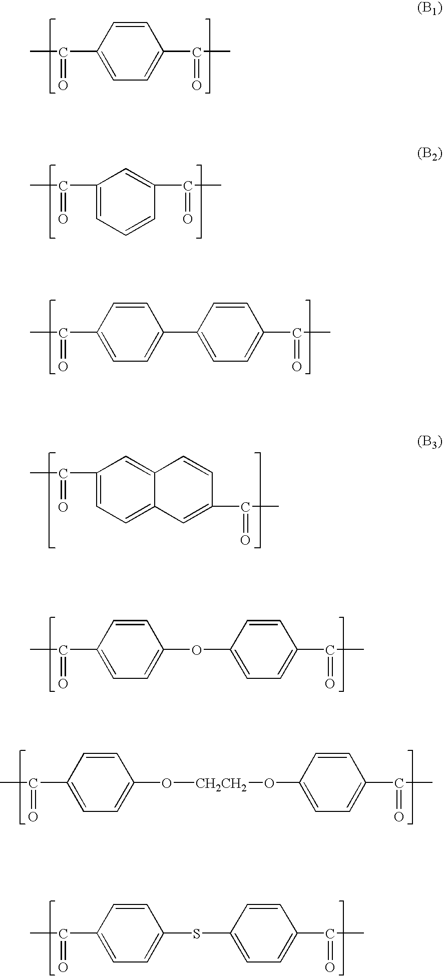

The above structural units may have a halogen atom, an alkyl group or an aryl group as a substituent.

<Structural Units Derived from an Aromatic Diol>

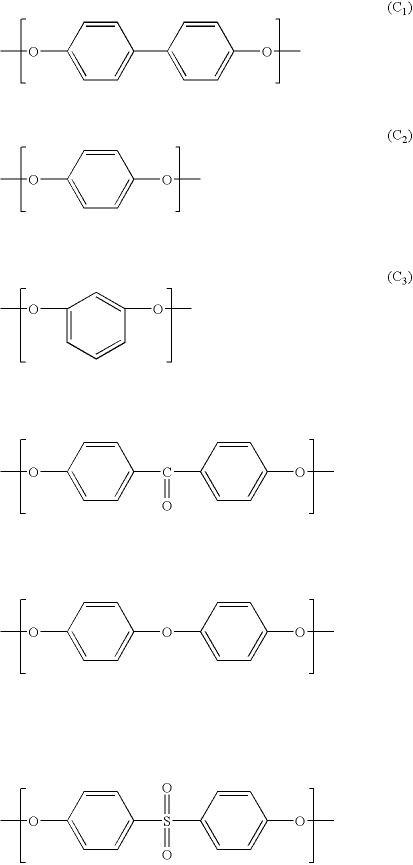

The above structural units may have a halogen atom, an alkyl group or an aryl group as a substituent.

A preferred liquid crystalline polyester has the structural units in one of the combinations (a) to (f) shown below:

(a) combination of the units (A₁), (B₁) and (C₁), or combination of the units (A₁), (B₁), (B₂) and (C₁);

(b) combination of the units (A₂), (B₃) and (C₂), or combination of the units (A₂), (B₁), (B₃) and (C₂);

(c) combination of the units (A₁) and (A₂);

(d) combination in which the unit (A₁) is partially or entirely replaced by the unit (A₂) in the combination (a);

(e) combination in which the unit (B₁) is partially or entirely replaced by the unit (B₃) in the combination (a);

(f) combination in which the unit (C₁) is partially or entirely replaced by the unit (C₃) in the combination (a);

(g) combination in which the unit (A₂) is partially or entirely replaced by the unit (A₁) in the combination (b); and

(h) combination in which the units (B₁) and (C₂) are added to the units in the combination (c).

As described above, the preferred liquid crystalline polyester used as the component (A) in the present invention has the units in the combinations (a) to (h). Namely, the liquid crystalline polyester preferably has the unit(s) (A₁) and/or (A₂) as the structural unit derived from the aromatic hydroxycarboxylic acid, at least one selected from the units (B₁), (B₂) and (B₃) as the structural unit derived from the aromatic diol, and at least one selected from the units (C₁), (C₂) and (C₃) as the structural unit derived from the aromatic dicarboxylic acid. As described above, the unit(s) (A₁) and/or (A₂), at least one of the units (B₁), (B₂) and (B₃), and at least one of the units (C₁), (C₂) and (C₃) may have a substituent on the aromatic ring. When higher heat resistance is required for the liquid crystalline polyester, these structural units preferably have no substituent.

The liquid crystalline polyester to be used as the component (A) preferably has a flow temperature within a range of from 270 to 400° C., and more preferably from 300 to 380° C. When a liquid crystalline polyester having a flow temperature within the above range is used as the component (A), the resulting reflection plate can sufficiently prevent deformation of the reflection plate itself and occurrence of blister (abnormal swelling) under a high temperature environment upon assembling of LED modules even when used in a light emitting device using a LED as a light emitting element, and thus a reflection plate can be produced at a practical melt processing temperature. In particular, when a trial of processing a reflection plate is made at a comparatively high melt processing temperature of higher than 400° C., heat degradation of a liquid crystalline polyester is likely to be caused by an influence of titanium oxide. In the worst case, the reflection plate may cause discoloration and the reflectance is likely to decrease.

Here, the flow temperature of the liquid crystalline polyester means a temperature at which the liquid crystalline polyester has a melt viscosity of 4,800 Pa˜sec under the conditions that the hot melt of the liquid crystalline polyester is extruded through a nozzle at a heating rate of 4° C./minute under a load of 9.8 MPa using a capillary rheometer of 1 mm in inner diameter and 10 mm in length. The flow temperature can be used as an indicator which corresponds to a molecular weight of a liquid crystalline polyester (see, “Synthesis, Molding and Application of Liquid crystallineline Polymer”, edited by Naoyuki Koide, pp. 95-105, CMC, published on Jun. 5, 1987).

The method for producing a liquid crystalline polyester used in the present invention is not limited, but it is preferred to use a method capable of producing a liquid crystalline polyester having a YI value of 32 or less (one of methods being disclosed in, for example, JP-A-2004-256673).

A preferred method for producing a liquid crystalline polyester disclosed in JP-A-2004-256673 will be described specifically.

A preferred method includes a method for producing a liquid crystalline polyester, which includes adding a fatty acid anhydride to a mixture of an aromatic hydroxycarboxylic acid, an aromatic diol and an aromatic dicarboxylic acid; reacting the mixture in a nitrogen atmosphere at 130 to 180° C. thereby reacting phenolic hydroxyl groups in the aromatic hydroxycarboxylic acid and the aromatic diol with the fatty acid anhydride, resulting in acylation of the phenolic hydroxyl group to obtain an acylated compound (an acylated aromatic hydroxycarboxylic acid and an acylated aromatic diol); and polycondensing so as to cause transesterification of acyl groups of the resulting acylated compound with carboxyl groups of the acylated aromatic hydroxycarboxylic acid and the aromatic dicarboxylic acid while distilling off the reaction by-product out of the reaction system with heating.

In the mixture of the aromatic hydroxycarboxylic acid, the acylated aromatic diol and the aromatic dicarboxylic acid, an equivalent ratio of the phenolic hydroxyl group to the carboxyl group is preferably from 0.9 to 1.1.

The amount of the fatty acid anhydride used based on the total equivalents of the phenolic hydroxyl groups of the aromatic diol and the aromatic dicarboxylic acid is preferably from 0.95 to 1.2 equivalents, and more preferably from 1.00 to 1.15 equivalents.

When the amount of the fatty acid anhydride used is small, coloration of the liquid crystalline polyester may be suppressed. However, when the amount of the fatty acid anhydride used is too small, the unreacted aromatic diol or aromatic dicarboxylic acid tends to be sublimated upon polycondensation and thus the reaction system may be closed. In contrast, when the amount of the fatty acid anhydride used is more than 1.2 equivalents, the resulting liquid crystalline polyester tend to be colored and may deteriorate a reflectance of the reflection plate.

Examples of the fatty acid anhydride to be used include, but are not limited to, acetic anhydride, propionic anhydride, butyric anhydride, isobutyric anhydride, valeric anhydride, pivalic anhydride, 2-ethylhexanoic anhydride, monochloroacetic anhydride, dichloroacetic anhydride, trichloroacetic anhydride, monobromoacetic anhydride, diobromoacetic anhydride, tribromoacetic anhydride, monofluoroacetic anhydride, difluoroacetic anhydride, trifluoroacetic anhydride, glutaric anhydride, maleic anhydride, succinic anhydride and β-bromopropionic anhydride. Two or more kinds of these fatty acid anhydrides may be used in combination. In view of cost and handing properties, acetic anhydride, propionic anhydride, butyric anhydride and isobutyric anhydride are preferably used, and acetic anhydride is particularly preferably used.

The transesterification (polycondensation) reaction is preferably conducted while heating at a rate of 0.1 to 50° C./minute within a range of from 130 to 400° C., and more preferably conducted while heating at a rate of 0.3 to 5° C./minute within a range of from 150 to 350° C.

As proposed in JP-A-2004-256673, the transesterification (polycondensation) reaction is preferably conducted in the presence of a heterocycic organic base compound containing two or more nitrogen atoms in order to produce a less-colored liquid crystalline polyester more smoothly.

Examples of such a heterocycic organic base compound (nitrogen-containing heterocyclic organic base compound) include an imidazole compound, a triazole compound, a dipyridilyl compound, a phenanthroline compound and a diazaphenanthrene compound. Among these heterocycic organic base compounds, an imidazole compound is preferably used in view of reactivity, and 1-methylimidazole and 1-ethylimidazole are more preferably used in view of availability.

The nitrogen-containing heterocyclic organic base compound may coexist in the reaction system in the stage of acylation, or the nitrogen-containing heterocyclic organic base compound may be mixed in the stage of mixing the aromatic hydroxycarboxylic acid, the aromatic diol and the aromatic dicarboxylic acid.

For the purpose of increasing the polycondensation rate by further promoting the transesterification (polycondensation) reaction, catalysts other than the nitrogen-containing heterocyclic organic base compound may be used as long as the objects of the present invention are not impaired. When a metal salt is used as the catalyst, the metal salt remains as impurities in the liquid crystalline polyester and therefore it may exert an adverse influence on electronic components like the reflection plate of the present invention. In this respect, use of the nitrogen-containing heterocyclic organic base compound is a particularly preferred embodiment in the production of the liquid crystalline polyester as the component (A).

Examples of the method of increasing the polymerization degree by further making progress of the transesterification (polycondensation) reaction include a method of evacuating the inside of a reaction vessel of the transesterification (polycondensation) reaction (vacuum polymerization) and a method of solidifying a reaction product with cooling, grinding the reaction product into a powder and heat-treating the resulting powder at 250 to 350° C. fro 2 to 20 hours (solid phase polymerization). It becomes easy to produce a liquid crystalline polyester having a preferred flow temperature by increasing the polymerization degree using such a method. In view of simple facility, a solid phase polymerization method is preferably used as the method of increasing the polymerization degree.

Polycondensation through acylation and transesterification and the subsequent vacuum polymerization and solid phase polymerization are preferably conducted under an inert gas (e.g. nitrogen) atmosphere since coloration of the liquid crystalline polyester can be sufficiently prevented.

The liquid crystalline polyester thus produced (which may be done by, for example, a method shown in JP-A-2004-256673) to have a YI value of 32 or less is particularly preferred as the component (A). The YI value is a color degree of object (such as a molded specimen of the liquid crystalline polyester), which can be measured using a calorimeter. The YI value is an indicator showing yellowness of the object to be measured. The YI value is a value defined in ASTM D1925 and can be determined by the equation below:

YI=[100(1.28X−1.06Z)/Y]

wherein X, Y and Z are respectively tristimulus values of a light source color in the XYZ calorimetric system.

The liquid crystalline polyester having a YI value of 32 or less obtained by the method using the nitrogen-containing heterocyclic organic base compound is particularly preferable as the component (A), and a liquid crystalline polyester mixture having a YI value of 32 or less, which is obtained by mixing plural kinds of liquid crystalline polyesters, can also be used as the component (A). Also in this case, a combination of liquid crystalline polyesters suited for the component (A) can be determined by measuring the YI value of the liquid crystalline polyester mixture using the above-mentioned method using the calorimeter.

### <Component (B)>

The resin composition for preparing a reflection plate of the present invention comprises a titanium oxide filler as component (B).

The titanium oxide filler may be mainly composed of titanium oxide and may be a titanium oxide which is commercially available as a filler for preparing a resin composition. It is possible to utilize the so-called titanium oxide commercially available as a filler for a resin composition as they are, and there is no need to exclude impurities contained therein. Surface-treated titanium oxide (described below) can also be used as the component (B).

The crystal form of the titanium oxide contained in the titanium oxide filler to be used as the component (B) is not limited. The titanium oxide may be rutile-type titanium oxide, an anatase-type titanium oxide, or a mixture thereof. In view of reflectance and light resistance of the resulting reflection plate, a titanium oxide filler containing rutile-type titanium oxide is preferably used.

The titanium oxide filler may have a particle-like shape or plate-like shape. The diameter (such as average particle diameter) of the titanium oxide filler is not limited. In order that the titanium oxide filler can be dispersed nearly uniformly in the resulting reflection plate, the average particle diameter is preferably in the range of from 0.01 to 10 μm, more preferably in the range of from 0.1 to 1 μm, and much more preferably in the range of from 0.1 to 0.5 μm. In view of reflectance of the resulting reflection plate, the average particle diameter is most preferably in the range of from 0.15 to 0.25 μm.

When the average particle diameter is larger than 10 μm, then the resulting reflection plate tend to be difficult to achieve an improvement in reflection rate provided by a silica-based filler (described below as component (C)). When the titanium oxide filler with the average particle diameter of from 0.01 to 10 μm is utilized, a relatively small-size reflection plate can be easily obtained.

The average particle diameter as used herein is a volume average particle diameter determined by the following procedure. That is, appearance of the titanium oxide filler is measured by a scanning electron microscope (SEM) and the resulting SEM micrograph is analyzed using an image analyzer (“LUZEX IIIU”, manufactured by Nireco Corporation). The amount of particles (%) in each particle diameter section of primary particles is plotted to obtain a distribution curve and a volume average particle diameter at 50% accumulation (average particle diameter) is determined from the cumulative distribution curve.

As described above, the titanium oxide filler as the component (B) may be a commercially available titanium oxide. The preferable titanium oxide filler having the preferable particle diameter may be selected among the commercially available titanium oxide, or may be obtained after classifying (or sifting) the commercially available titanium oxide.

Alternatively, the titanium oxide filler having the preferable particle diameter may be the titanium oxide which has been obtained by a known method. The titanium oxide filler preferably contains a titanium oxide obtained by a so-called “chlorine method”. In the chlorine method, ores as a titanium source (such as synthesized rutile-type titanium oxides) is reacted with chlorine at about 1000° C. to obtaine a titanium tetrachloride, which is then subjected to rectification to obtain a purified titanium tetrachloride, followed by oxidation with oxygen to obtain a titanium oxide. The chlorine method can provide rutile-type titanium oxides, which are preferable in the present invention. By controlling the conditions of the oxidation step, a titanium oxide with an excellent whiteness can be easily obtained, and the titanium oxide filler mainly composed of the thus obtained titanium oxide is preferably used as the component (B) in the present invention.

The content of the titanium oxide filler as the component (B) in the reflection plate of the present invention is preferably from 5 to 80 parts by weight, and more preferably from 10 to 75 parts by weight, on the weight basis of 100 parts by weight of the component (A). When the amount is smaller than 5 parts by weight, the reflection plate may possess an insufficient reflectance. In contrast, when the amount is larger than 80 parts by weight, it tends to become difficult to produce a reflection plate and characteristics such as heat resistance are not sufficiently maintained depending on the kind of the liquid crystalline polyester. When the amount of the component (B) is within the above range, a reflection plate having an excellent reflectance can be produced with a synergistic effect with the silica-based filler (described below, as component (C)) while sufficiently maintaining excellent characteristics of the liquid crystalline polyester.

When a plurality kinds of titanium oxide fillers are used as the component (B), the total amount of the fillers is within the above range.

For the purpose of more improving characteristics such as dispersibility, the titanium oxide filler as the component (B) may be subjected to a surface treatment. There is no specific limitation on the surface treatment. In view of dispersibility of the titanium oxide filler and weatherability of the resulting reflection plate, a surface treatment with an inorganic metal oxide is preferred, and the inorganic metal oxide is preferably an aluminum oxide (i.e., alumina). The surface treatment is not always needed if the titanium oxide filler is not agglomerated is easy to handle. When the titanium oxide filler with no surface treatment is used, the resulting reflection plate tends to possess the more improved heat resistance and strength.

Examples of a commercially available titanium oxide filler which can be used as the component (B) include “TIPAQUE CR-60” (manufactured by Ishihara Sangyo Kaisha Ltd.).

### <Component (C)>

The resin composition for preparing a reflection plate of the present invention comprises a silica-based filler (component (C)) which mainly contains silicon oxide.

The silica-based filler to be used as the component (C) means a filler containing silicon oxide (SiO₂) and is typically a filler containing 85% by weight or more of silicon oxide. The component (C) is more preferably a filler containing 90% by weight or more of silicon oxide, and much more preferably a filler containing 95% by weight or more of silicon oxide.

The present inventors have found that a reflection plate having an extremely high reflectance can be obtained by using such a silica-based filler while controlling the amount of the titanium oxide filler as the component (B) so as not to cause drastic deterioration of the liquid crystalline polyester.

The silica-based filler preferably may have a particle-like shape or plate-like shape. The diameter (such as average particle diameter) of the silica-based filler is preferably in the range of from 0.2 to 50 μm, more preferably in the range of from 0.5 to 20 μm, and much more preferably in the range of from 1 to 10 μm. When the diameter is smaller than 0.2 μm, the resulting reflection plate may transmit light and a smaller addition effect of the silica-based filler may be exerted. In contrast, when the diameter is larger than 50 μm, processability of a small-shaped reflection plate tends to deteriorate. It is preferred to use a silica-based filler having an optimum average particle diameter in consideration of the thickness of the reflection plate to be produced. When the diameter of the silica-based filler is within the above range, an excellent reflectance can be exhibited and also the processability is excellent even when a small-shaped reflection plate is produced.

The method for the measurement of the average particle diameter of the silica-based filler as used herein employs Laser Diffraction/Scattering-Method Particle Size Distribution Analyzer (trade name: LA-910, manufactured by HORIBA, Ltd.) according to JIS B 9925.

While the silica-based filter may have any shape such as a spherical, cubic, needle-like, rod-like, hanging bell-like, tabular, scaly or fiber shape, the silica-based filter preferably has a particle shape (spherical shape), as described above. A substantially spherical shape is preferred. The expression “substantially spherical shape” means a spherical shape having an average sphericity of 0.7 to 1. The average sphericity can be measured by the following procedure.

### <Measurement of Average Sphericity>

Micrographs of the appearance of particles taken by a stereoscopic microscope (Model “SMZ-10”, manufactured by Nikon Corporation) or a scanning electron microscope are taken into an image analyzer (for example, an image analyzer manufactured by Nippon Avionics Co., Ltd.) to obtain a particle image. A project area (A) and a peripheral length (PM) are measured from the resulting particle image. When an area of a complete circle corresponding to the peripheral length (PM) is (B), the circularity of the particle can be indicated as A/B. Assuming a complete circle having the same peripheral length as the peripheral length (PM) of the sample particle, since PM=2πr and B=πr², the following equation: B=π×(PM/2π)² is established. Thus, the degree of sphericity of each particle can be calculated as follows.

Degree of sphericity=A/B=A×4π/(PM)²

The obtained particle size of arbitrary number of particles is determined and an average thereof is taken as an average sphericity.

As the component (C), the silica-based filler may be used alone, or two or more kinds of them may be used in combination. In both cases, the total amount of the component (C) is preferably in the range of from 0.01 to 20 parts by weight, more preferably in the range of from 0.03 to 15 parts by weight, and much more preferably in the range of from 0.05 to 10 parts by weight, on the basis of 100 parts by weight of the liquid crystalline polyester as the component (A). When the amount of the silica-based filler used is within the above range, a reflection plate capable of realizing a high reflectance can be obtained by a synergistic effect with the component (B). When the silica-based filler is used in the amount smaller than the above range, the effect of improving a reflectance may be hardly obtained. As the amount of the silica-based filler used increases, the effect of improving a reflectance is recognized. Since the effect of improving a reflectance may decrease when the amount is larger than 20 parts by weight, the silica-based filler is used in the amount of 20 parts by weight or less per 100 parts by weight of the liquid crystalline polyester in the present invention. A commercially available silica-based filler, which may have absorbed moisture in the air, can be used in the above range. When such a moisture-absorbed silica-based filler is preferably used in the amount of larger than 20 parts by weight, the liquid crystalline polyester as the component (A) may be sometimes hydrolyzed upon melt processing. In order to suppress such a hydrolysis, the amount of the silica-based filler is preferably 20 parts by weight or less. The moisture absorbed in the silica-based filler can be removed by vacuum-drying the silica-based filler at a temperature of about 200° C. for several hours.

The silica-based filler as the component (C) can not be replaced with a commonly used glass-based filler (such as glass beads) which contains 60% by weight or less of silicon oxide.

Examples of a commercially available product of the silica-based filler which can be used as the component (C) include spherical silica “FB or FBX SERIES: FB-105” manufactured by Denki Kagaku Kogyo Kabushiki Kaisha; and “SILICA MICROBEADS SERIES: P-500” manufactured by Shokubai Kasei Co., Ltd.

### <Resin Composition>

The reflection plate of the present invention can be obtained from a resin composition comprising the above-mentioned components (A), (B) and (C) wherein the amounts of the components (A), (B) and (C) in the resin composition are as described above. The resin composition will be described in more detail below.

If necessary, an inorganic filler other than the components (B) and (C) may be used as a composition (D) in the resin composition.

When the composition (D) is used, the amount of the component (D) is preferably in the range of from 5 to 100 parts by weight, and more preferably in the range of from 5 to 90 parts by weight on the basis of 100 parts of the total weight of the components (A), (B) and (C). When the amount of the component (D) is more than 100 parts by weight, color tone of the resulting reflection plate may deteriorate and the melt viscosity of the resin composition may increase, which may deteriorate granulating properties of the granules of the resin composition for producing a reflection plate. Also, moldability of the resin composition may deteriorate when a small-sized reflection plate is produced.

As the component (D), a fiber-shaped filler or a whisker-shaped filler of the inorganic filler other than the components (B) and (C) is preferably used since it does not cause drastic decrease of the reflectance. Examples of such an inorganic filler as the component (D) include a glass fiber containing 80% by weight or less of silicon oxide, a carbon fiber, a metal fiber, an alumina fiber, a boron fiber, a titanate fiber, wollastonite and asbestos; and whisker-shaped inorganic fillers such as silicon carbide, alumina, boron nitride, aluminum borate and silicon nitride.

Among these, inorganic fibers such as a glass fiber containing 80% by weight or less of silicon oxide, a titanate fiber and wollastonite; and whisker-shaped inorganic fillers such as aluminum borate and silicon nitride are preferred so as to impart practical mechanical strength to the reflection plate without causing drastic decrease of the reflectance of the reflection plate.

In these inorganic fillers, a sizing agent may also be used. It is preferred to use a small amount of the sizing agent so as to maintain a high reflectance of the reflection plate by suppressing deterioration of the color tone.

As long as the effects of the present invention are not significantly impaired, a white pigment other than the titanium oxide filler may also be used. Examples of the white pigment include zinc oxide, zinc sulfide and white lead.

As long as the effects of the present invention are not impaired, a conventional additives such as release improvers such as fluororesins, higher fatty acid ester compounds and fatty acid metal soaps; colorants such as dyes and pigments; antioxidants; heat stabilizers; fluorescent whiteners; ultraviolet absorbers; antistatic agents; and surfactants may be added to the resin composition. An external lubricant such as higher fatty acids, higher fatty acid esters, higher fatty acid metal salts and fluorocarbon-based surfactants may also be added. When the above additive is used, the kind of and/or the amount of the additive are appropriately determined so as not to edversely affect the resulting reflection plate.

### <Reflection Plate>

The reflection plate can be produced by a method comprising the steps of a preparation step of resin composition comprising components (A), (B) and (C) and the optional component (D) and an injection-molding step of the resin composition. For example, the reflection plate of the present invention can be obtained by a method comprising the steps of:

mixing (A) 100 parts by weight of a liquid crystalline polyester, (B) 5 to 80 parts by weight of a titanium oxide filler and (C) 0.01 to 20 parts by weight of a silica-based filler containing 85% by weight or more of silicon oxide to preparing a resin composition; and injection-molding the resin composition.

Examples of the method used in the preparation step includes a method of mixing components (A), (B) and (C) and the optional component (D) using a Henschel mixer or a tumbler, and melt-kneading the mixture using an extruder. Pelletization of the resin composition by melt-kneading, followed by the molding step, is preferred. The resin composition subjected to pelltization shows improved handling properties and the range of choice of preferred molding method can be widened by the shape of the intended reflection plate.

Examples of the molding method used in the molding step include an injection molding method, an injection compression molding method and an extrusion molding method. Among these, an injection molding method is preferred and it becomes possible that the refection plate obtained by injection molding has a thin wall section. Injection molding is particularly suited for a small-sized reflection plate whose thin wall section has a thickness of 0.03 to 3 mm, preferably 0.05 to 2 mm, and more preferably 0.05 to 1 mm. When a reflection plate is produced by injection molding, a mold having a miller-finished surface in contact with a molten resin is preferably used so as to improve surface smoothness of the resulting reflection plate.

The molding temperature of melt molding such as injection molding is preferably higher by the temperature of from about 10° C. to about 60° C. than the flow temperature of the resin composition to be used. When the molding temperature is lower than the above temperature, fluidity may drastically decrease thereby causing deterioration of moldability and decrease in the strength of the reflection plate. In contrast, when the molding temperature is higher than the above temperature, the liquid crystalline polyester may drastically deteriorate thereby causing decrease in the reflectance of the reflection plate. The flow temperature of the resin composition can be determined in the same manner as that explained as a method for measuring the flow temperature of the liquid crystalline polyester, using a capillary rheometer.

The reflection plate obtained by the present invention can have a remarkably excellent reflectance to light in a visible range. For example, the reflection plate may have a reflectance of 70% or more to light with a wavelength of 460 nm. It is also possible to produce a reflection plate having a reflectance of 75% or more. Some reflection plates obtained by the present invention may have a reflectance of as high as 80% or more. The reflectance as used herein is determined based on a method A for the measurement of an entire light reflectance (standard white plate: barium sulfate) in accordance with JIS K7105-1981.

### <Light Emitting Device>

The reflection plate of the present invention can be suitably used as a reflection plate which requires light reflection, especially reflection to light in a visible range in the fields of electricities, electronics, automobiles and machines. For example, the reflection plate can be preferably used as a lamp reflector of light source devices such as a halogen lamp and HID, a reflection plate of light emitting devices such as LED(s) and organic EL devices, and a reflection plate of display devices. In a light emitting device using a LED as a light emitting element, the reflection plate is sometimes exposed to a high-temperature environment in a mounting step and a soldering step of the element. However, the reflection plate of the present invention has an advantage that deformation such as blister does not occur even after passing through a high-temperature process. Therefore, when the reflection plate of the present invention is used for a light emitting device using a LED as a light emitting element, a light emitting device having excellent characteristics such as luminance can be obtained.

The invention being thus described, it will be apparent that the same may be varied in many ways. Such variations are to be regarded as within the spirit and scope of the invention, and all such modifications as would be apparent to one skilled in the art are intended to be within the scope of the following claims.

### EXAMPLES

The present invention is described in more detail by following Examples, which should not be construed as a limitation upon the scope of the present invention.

Physical properties in examples were measured by the following procedures.

### (1) Reflectance

Using an automatic recording spectrophotometer (U-3500, manufactured by Hitachi, Ltd.), a diffuse reflectance to light having a different wavelength (measurement was conducted at three measuring wavelengths of 460 nm, 520 nm and 640 nm) was measured by irradiating the surface of a reflection plate specimen measuring 64 mm×64 mm×1 mm. The reflectance is a relative value assuming that the diffuse reflectance of a standard white plate of barium sulfate is 100%.

### (2) Evaluation of Heat Resistance to Solder at 300° C.

Each of minidumbbell-shaped specimens (1.2 mm in thickness)(JIS K71131 (1/2)) which had been formed of liquid crystalline resin compositions of examples and comparative examples was immersed in a solder bath heated to 300° C. for one minute. The case where a molded body was not deformed was rated “◯”, whereas, the case where a molded body was deformed was rated “×”.

Fillers used to obtain reflection plate specimens in examples and comparative examples are as follows:

Titanium oxide filler (CR-60), which is TIPAQUE CR-60 (manufactured by Ishihara Sangyo Kaisha Ltd.), treated with alumina at surface, having an average particle diameter of 0.21 μm;

Titanium oxide filler (CR-58), which is TIPAQUE CR-58 (manufactured by Ishihara Sangyo Kaisha Ltd.), treated with alumina at surface, having an average particle diameter of 0.28 μm;

Silica-based filler (P-500), which is Silica Beads P-500 (manufactured by Shokubai Kasei Co., Ltd.), having an average particle diameter of about 2 μm, an average sphericity of 0.7 or more and a silicon oxide content of 90% by weight or more;

Silica-based filler (FB-105), which is Silica Beads P-105 (manufactured by Denki Kagaku Kogyo Kabushiki Kaisha), having an average particle diameter of about 12 μm, an average sphericity of 0.7 or more and a silicon oxide content of 90% by weight or more;

Glass fiber, which is EFH75-01 (manufactured by Central Glass Co., Ltd.); and

Glass beads, which is UBS-0010L (manufactured by UNITIKA LTD.), mede of E glass (having a silicon oxide content of from 52% to 56%).

### Example 1

In a reactor equipped with a stirrer, a torque meter, a nitrogen gas introducing tube, a thermometer and a reflux condenser, 994.5 g (7.2 mol) of parahydroxybenzoic acid, 446.9 g (2.4 mol) of 4,4′-dihydroxybiphenyl, 299 g (1.8 mol) of terephthalic acid, 99.7 g (0.6 mol) of isophthalic acid and 1347.6 g (13.2 mol) of acetic anhydride were charged and 0.2 g of 1-methylimidazole was added. After sufficiently replacing the atmosphere in the reactor by a nitrogen gas and heating to 150° C. over 30 minutes under a nitrogen gas flow, the mixture was refluxed for one hour while maintaining the temperature.

1-Methylimidazole (0.9 g) was added and, after heating to 320° C. over 2 hours and 50 minutes while distilling off acetic acid produced as a by-product and unreacted acetic anhydride. After completion of the reaction, namely, an increase in torque was recognized, a prepolymer was obtained.

The resulting prepolymer was cooled to room temperature, ground by a coarse grinder, heated to 250° C. from room temperature over one hour under a nitrogen atmosphere, heated to 285° C. from 250° C. over 5 hours and maintained at 285° C. for 3 hours, and thus progress of the solid phase polymerization reaction was made. The resulting liquid crystalline polyester had a flow temperature of 327° C. and YI value of about 32. The liquid crystalline polyester thus obtained is referred to as liquid crystalline polyester 1.

The resulting liquid crystalline polyester 1 was mixed with titanium oxide and an inorganic filler in a mixing ratio shown in Table 1 and then kneaded using a twin-screw extruder (PCM-30, manufactured by Ikegai Iron Works Co., Ltd.) to obtain a liquid crystalline polyester resin composition. The resulting liquid crystalline polyester resin composition was molded at 340° C. using an injection molding machine (Model PS40E5ASE, manufactured by Nissei Plastic Industrial Co., Ltd.) to obtain a reflection plate specimen measuring 64 mm×64 mm×1 mm. The specimen was used for measurement. The results are shown in Table 1. A mirror-finished mold was used for molding of the specimen.

### Examples 2 to 5 and Comparative Examples 1 to 6

The liquid crystalline polyester 1 used in Example 1 was mixed with various fillers in a mixing ratio shown in Table 1 to obtain a resin composition. In the same manner as in Example 1, reflection plate specimens were obtained and various measurements were conducted. The results are shown in Table 1 and Table 2.

TABLE 1

| | | Example 1 | Example 2 | Example 3 | Example 4 | Example 5 |
|---|---|---|---|---|---|---|
| Resin | Liquid crystalline | 100 | 100 | 100 | 100 | 100 |
| composition | polyester 1 | | | | | |
| | (parts by weight) | | | | | |
| | Titanium oxide CR-60 | 40 | 40 | 40 | 40 | 0 |
| | (parts by weight) | | | | | |
| | Titanium oxide CR-58 | 0 | 0 | 0 | 0 | 40 |
| | (parts by weight) | | | | | |
| | Glass fiber | 60 | 60 | 60 | 60 | 60 |
| | (parts by weight) | | | | | |
| | Silica beads P-500 | 0.4 | 2 | 10 | 0 | 0 |
| | (parts by weight) | | | | | |
| | Silica beads FB-105 | 0 | 0 | 0 | 0.4 | 0.4 |
| | (parts by weight) | | | | | |
| | Glass beads | 0 | 0 | 0 | 0 | 0 |
| | (parts by weight) | | | | | |
| Reflectance | Measuring wavelength | | | | | |
| | 640 nm | 88.5% | 88.5% | 89.0% | 86.8% | 87.6% |
| | 520 nm | 85.1% | 85.1% | 85.6% | 83.7% | 84.9% |
| | 460 nm | 81.3% | 81.4% | 81.9% | 80.6% | 82.2% |

| | | | | | |
|---|---|---|---|---|---|
| Heat resistance to solder | ◯ | ◯ | ◯ | ◯ | ◯ |
| deformation at 300° C. | | | | | |

TABLE 2

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Resin | Liquid crystalline | 100 | 100 | 100 | 100 | 100 | 100 |
| Composition | polyester 1 | | | | | | |
| | (parts by weight) | | | | | | |
| | Titanium oxide CR-60 | 40 | 100 | 40 | 40 | 40 | 0 |
| | (parts by weight) | | | | | | |
| | Titanium oxide CR-58 | 0 | 0 | 0 | 0 | 0 | 40 |
| | (parts by weight) | | | | | | |
| | Glass fiber | 60 | 0 | 60 | 60 | 60 | 60 |
| | (parts by weight) | | | | | | |
| | Silica beads P-500 | 0 | 0 | 0 | 0 | 0 | 0 |
| | (parts by weight) | | | | | | |
| | Silica beads FB-105 | 0 | 0 | 0 | 0 | 0 | 0 |
| | (parts by weight) | | | | | | |
| | Glass beads | 0 | 0 | 0.4 | 2 | 10 | 0 |
| | (parts by weight) | | | | | | |
| Reflectance | Measuring wavelength | | | | | | |
| | 640 nm | 86.3% | 90.2% | 85.6% | 85.7% | 85.0% | 87.0% |
| | 520 nm | 82.7% | 88.0% | 82.2% | 82.2% | 81.3% | 84.1% |
| | 460 nm | 78.9% | 82.0% | 78.1% | 78.1% | 76.9% | 81.3% |

| | | | | | | |
|---|---|---|---|---|---|---|
| Heat resistance to solder | ◯ | X | ◯ | ◯ | ◯ | ◯ |
| deformation at 300° C. | | | | | | |

As shown in Table 1, the specimens containing all the components (A) to (C) exerted the higher reflectance (see, Examples 1 to 5), compared with the specimens containing no silica-based filler (component (C)) added therein (see, Comparative Examples 1 to 5). It was found that, although a specimen having a high reflectance can be obtained by using a large amount of a titanium oxide filler (see, Comparative 2), the specimen has drastically deteriorated heat resistance to solder. In the specimens containing a filler made of glass (glass beads) in place of the silica-based filler (see, Comparative Examples 3 to 5), the specimens has lower reflectance when compared with not only the specimens obtained in Examples 1 to 5, but also the specimen obtained in Comparative Example 1. The results above show the advantages of the present of the silica-based filler as component (C) in the present invention. The resin composition having a high reflectance and satisfactory heat resistance to solder can be easily made into a reflection plate having excellent reflectance and heat resistance.

What is claimed is:

1. A reflection plate made of a resin composition comprising:
(A) a liquid crystalline polyester,
(B) a titanium oxide filler, and
(C) a silica-based filler containing 85% by weight or more of silicon oxide,
wherein the resin composition contains the titanium oxide filler in the amount of from 5 to 80 parts by weight and the silica-based filler in the amount of from 0.01 to 20 parts by weight on the basis of 100 parts by weight of the liquid crystalline polyester.

2. The reflection plate according to claim 1, wherein the silica-based filler is in the shape of substantial particle.

3. The reflection plate according to claim 1, wherein the silica-based filler and the titanium oxide are in the shape of substantial particle.

4. The reflection plate according to claim 2, further comprising:
(D) a fiber-shaped or whisker-shaped inorganic filler other than the titanium oxide filler and the silica-based filler.

5. The reflection plate according to claim 4, wherein the resin composition contains the inorganic filler in the amount of from 5 to 100 parts by weight on the basis of 100 parts by weight of the total amount of the liquid crystalline polyester, the titanium oxide filler and the silica-based filler.

6. The reflection plate according to claim 1, which has a thin wall section having a thickness of 0.01 to 3 mm.

7. The reflection plate according to claim 1, wherein the reflection plate possesses 70% or more of reflectance to light having a wavelength of 460 nm when measured by method A for the measurement of an entire light reflectance in accordance with JIS K7105-1981.

8. A method for producing a reflection plate, the method comprising the steps of:
mixing (A) 100 parts by weight of a liquid crystalline polyester, (B) 5 to 80 parts by weight of a titanium oxide filler and (C) 0.01 to 20 parts by weight of a silica-based filler containing 85% by weight or more of silicon oxide to preparing a resin composition; and injection-molding the resin composition.

9. A light emitting device having the reflection plate according to claim 1 and a light emitting element.

10. The light emitting device according to claim 9, wherein the light emitting element is a light emitting diode.
